(19) United States
(12) Patent Application Publication
(10) Pub. No.: US 2015/0237987 A1
(43) Pub. Date: Aug. 27, 2015

(54) BLING NAIL STICKER AND MANUFACTURING METHOD THEREOF

(71) Applicant: SUNG YONG CHANG, Roslyn Heights, NY (US)

(72) Inventor: SUNG YONG CHANG, Roslyn Heights, NY (US)

(21) Appl. No.: 14/706,462

(22) Filed: May 7, 2015

Related U.S. Application Data
(63) Continuation of application No. 13/310,085, filed on Dec. 2, 2011.

(30) Foreign Application Priority Data
Jul. 11, 2011 (KR) 10-2011-0068362
Oct. 13, 2011 (KR) 10-2011-0104597

(51) Int. Cl. A45D 29/00; B05D 7/00

(52) U.S. Cl. CPC A45D 29/001; B05D 7/56

(57) ABSTRACT

Provided is a bling nail sticker, including a substrate layer on which a pattern is printed, and a three-dimensional ornamental portion disposed on the top surface of the substrate layer and having a pattern formed of a luminant material, such as a jewel, wherein the three-dimensional ornamental portion includes: a luminant reflective layer printed on the top surface of the substrate layer; a transparent coating layer printed on the top surface of the substrate layer at the position where the reflective layer is formed, and allowing light transmission to the reflective layer; and a three-dimensional layer applied and adhered to the top surface of the coating layer. In the bling nail sticker, the three-dimensional ornamental portion may be positioned at a predetermined site in the same manner as attaching a jewel to the site. In addition, since the three-dimensional ornamental portion is provided by using a printing process, it is possible to control the size and position of the three-dimensional ornamental portion with ease, resulting in a decrease in time during the manufacture.

### CROSS-REFERENCE TO RELATED APPLICATIONS

This application is a continuation of U.S. patent application Ser. No. 13/310,085, entitled “BLING NAIL STICKER AND MANUFACTURING METHOD THEREOF” and filed Dec. 2, 2011, which application claims priority under 35 U.S.C. §119 to Korean Patent Applications Nos. 10-2011-0068362 and 10-2011-0104597, filed on Jul. 11, 2011 and Oct. 13, 2011, respectively, in the Korean Intellectual Property Office, each of which is hereby incorporated by reference in its entirety.

### TECHNICAL FIELD

The following disclosure relates to a bling nail sticker, and more particularly to a bling nail sticker having a luminant three-dimensional ornamental portion that causes light reflection at a uniform position with a uniform magnitude.

### BACKGROUND

In general, when users intend to improve the shapes of their nails, they apply manicure on their nails or attach a three-dimensional ornament such as cubic to their nails. Therefore, nail art workers manually attach three-dimensional ornaments to nails to improve the appearance thereof. In this case, the users ask a technical specialist of nail art, working in a nail shop or the like, to improve the shapes of their nails or they attach three-dimensional ornaments to their nails by themselves. However, when the users ask a technical specialist to perform nail art, they pay for the nail art work every time they need the service, and thus they have burdened themselves with high cost. On the other hand, when the users attach three-dimensional ornaments to their nails by themselves, the pattern to be attached to each nail may be varied due to different skills exerted by both hands.

When it is desired to provide a nail with a glittering effect, three-dimensional ornaments made of jewels may be attached to nails. However, when non-skilled persons fail in attempt to attach such three-dimensional ornaments to their nails at once, the cost needed to accomplish desired nail art work becomes too expensive due to the high cost of such three-dimensional ornaments made of jewels.

Therefore, to overcome the above-mentioned problems, there has been a need for developing a bling nail sticker and a method for manufacturing the same, so that even non-skilled persons may improve the appearance of their nails with a uniform shape in a simple manner when they intend to provide their nails with a three-dimensional glittering effect.

### SUMMARY

An embodiment of the present invention is directed to providing a bling nail sticker capable of creating the same effect as attaching a three-dimensional ornament such as a jewel at a predetermined position under uniform adhesive force and reducing the manufacturing time.

Another embodiment of the present invention is directed to providing a method for manufacturing the bling nail sticker.

In one general aspect, there is provided a bling nail sticker, including a substrate layer on which a pattern is printed, and a three-dimensional ornamental portion disposed on the top surface of the substrate layer and having a pattern formed of a luminant material, such as a jewel,

wherein the three-dimensional ornamental portion includes:

a luminant reflective layer printed on the top surface of the substrate layer;

a transparent coating layer printed on the top surface of the substrate layer at the position where the reflective layer is formed, and allowing light transmission to the reflective layer; and

a three-dimensional layer applied and adhered to the top surface of the coating layer.

According to an embodiment, the reflective layer may have a pattern formed with metallic ink.

The reflective layer may include at least one of a metal thin film and metal powder.

A reflector fixing layer may be further formed between the reflective layer and the substrate layer.

The three-dimensional layer may be formed by a silk screen printing process.

An adhesive layer and a release sheet protecting the adhesive layer may be further formed on the bottom surface of the substrate layer.

The substrate layer may be obtained by using at least one selected from polyethylene terephthalate (PET), oriented polypropylene (OPP), polypropylene (PP), polystyrene (PS), polyethylene (PE), polyvinyl chloride (PVC), polyvinylidene chloride (PVDC), ethylene vinyl acetate (EVA), polyurethane (PU) and paper sheets.

The coating layer may include at least one selected from UV resins, urethane resins, acrylic resins, cellulose resins, polyester resins, vinyl resins, polyamide resins, epoxy resins, alkyd resins and latex-casein.

The three-dimensional layer may include any one selected from epoxy resins, silicone resins, epoxy-silicone resin blends, acrylic resins, urethane resins, and acrylic-urethane resin blends.

The three-dimensional layer may further include at least one selected from dyes and luminant glitters capable of light transmission to the reflective layer.

The three-dimensional layer may have a convex curvature so that light may be collected at the reflective layer.

The three-dimensional layer may have a contact angle of 20° to 70°.

In another general aspect, there is provided a method for manufacturing the bling nail sticker, including:

forming a pattern including the shape of a reflective layer on the top of a substrate layer according to a target design pattern;

applying a coating layer to a site where a three-dimensional ornamental portion is to be formed; and

forming a three-dimensional layer at the coating layer-applied site where a three-dimensional ornamental is to be formed.

According to an embodiment, the coating layer may be applied to the whole surface of the substrate layer.

Other features and aspects will be apparent from the following detailed description and the claims.

### BRIEF DESCRIPTION OF THE DRAWINGS

The above and other aspects, features and advantages of the disclosed exemplary embodiments will be more apparent from the following detailed description taken in conjunction with the accompanying drawings in which:

FIG. 1 is a perspective view showing the bling nail sticker according to an embodiment.

FIG. 2 shows sectional views of the bling nail stickers according to some embodiments.

FIG. 3 is a flow chart illustrating the method for manufacturing a bling nail sticker according to an embodiment.

### DETAILED DESCRIPTION OF EMBODIMENTS

The advantages, features and aspects of the present invention will become apparent from the following description of the embodiments with reference to the accompanying drawings, which is set forth hereinafter. The present invention may, however, be embodied in different forms and should not be construed as limited to the embodiments set forth herein. Rather, these embodiments are provided so that this disclosure will be thorough and complete, and will fully convey the scope of the present invention to those skilled in the art. The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

In general, to impart a glittering effect to a portion of nail, three-dimensional ornaments such as jewels have been attached manually and directly to nails. Unlike the related art, the bling nail sticker disclosed herein is obtained by forming the pattern of a reflective layer 120a with a glittering material and by covering the top surface of the reflective layer 120a with a transparent material in a convex shape. The three-dimensional ornamental portion 120 obtained as mentioned above has a sense of volume and luminant property. Thus, it is possible for the three-dimensional ornamental portion 120 to realize the shape of a three-dimensional ornament having glittering property. In other words, it is possible to control the pattern, size and position of the three-dimensional ornamental portion 120 formed on the bling nail sticker disclosed herein through a printing process. Therefore, unlike other manually attached three-dimensional ornaments, the three-dimensional ornamental portion 120 may have a uniform design. In addition, it is possible to prevent thermal deformation of a substrate layer 110 during the formation of the three-dimensional ornamental portion 120. Further, it is possible to reduce the time required for manufacturing the bling nail sticker.

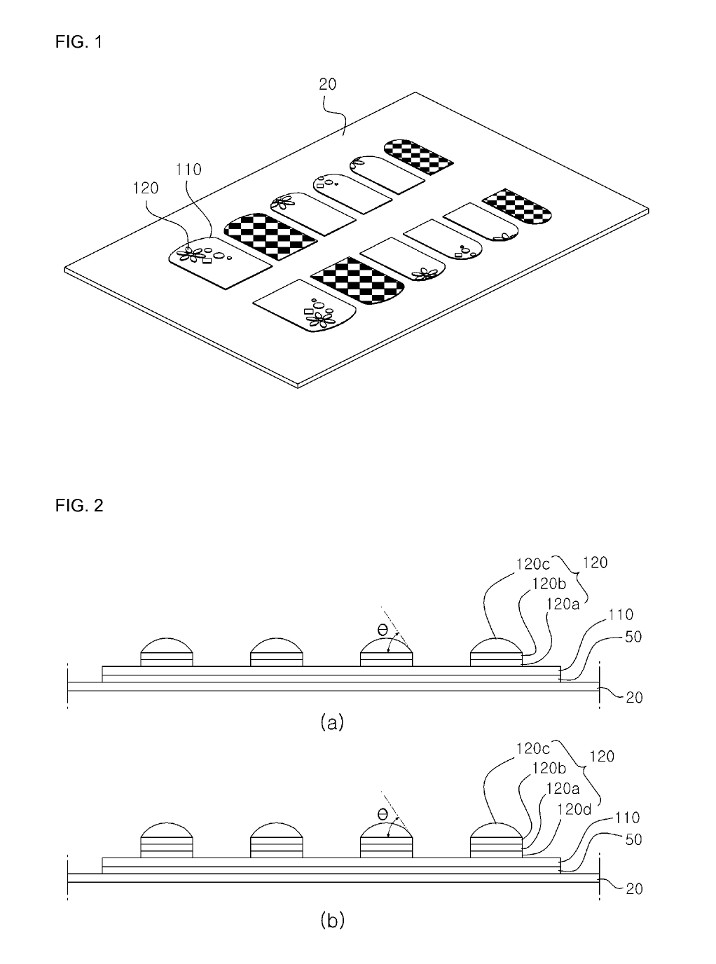

FIG. 1 is a perspective view showing the bling nail sticker according to an embodiment.

In one aspect, there is provided a bling nail sticker, including a substrate layer 110 on which a pattern is printed, and a three-dimensional ornamental portion 120 disposed on the top surface of the substrate layer 110 and having a pattern formed of a luminant material, such as a jewel,

wherein the three-dimensional ornamental portion 120 includes:

a luminant reflective layer 120a printed on the top surface of the substrate layer 110;

a transparent coating layer 120b printed on the top surface of the substrate layer 110 at the position where the reflective layer 120a is formed, and allowing light transmission to the reflective layer 120a; and

a three-dimensional layer 120c applied and adhered to the top surface of the coating layer 120b.

According to an embodiment, the three-dimensional ornamental portion 120 may be formed over the whole surface of the substrate layer 110. According to another embodiment, the three-dimensional ornamental portion 120 may be provided on a portion of the substrate 110 and the remaining portion thereof may have another design.

The bling nail sticker disclosed herein may be provided in the form of a sticker having no additional adhesive on the bottom of the substrate 110. In a variant, as shown in FIG. 1, the substrate layer 110 may have an additional adhesive applied on the bottom of the substrate layer 110, so that bling nail stickers with different sizes may be provided as a set. Herein, the substrate layer 110 has a planar shape, and may be resistant to wrinkling even when applied to a curved surface, such as nail, and adhered closely to the curved surface. Therefore, the substrate layer 110 may include at least one material selected from PET, OPP, PP, PS, PE, PVC, PVDC, EVA, PU and paper sheets. In other words, the above-listed materials may be used alone or in combination.

According to another embodiment, the luminant reflective layer 120a may have a three-dimensional layer 120c on the top thereof, so that the three-dimensional ornamental portion 120 protrudes out from the substrate layer 110. As used herein, the term “three-dimensional ornaments” does not mean that the ornament merely has a three-dimensional shape but is defined as jewels provided with both luminant property and a three-dimensional effect.

FIG. 2 shows sectional views of the bling nail stickers according to some embodiments.

The luminant reflective layer 120a is printed on the top surface of the substrate layer 110 to provide the shape of a three-dimensional ornament. Through a process including printing a material having luminant property on a substrate layer 110 and coating a three-dimensional layer 120c thereon, it is possible to enhance the three-dimensional effect of the luminant material. Therefore, it is possible to provide a planar printed design with a three-dimensional effect, thereby realizing the same effect as attaching a three-dimensional ornament.

As shown in FIG. 2a, the reflective layer 120a may be patterned with metallic ink. The metallic ink includes a material, such as metal, reflected by light, and thus is used to realize a desired pattern on the substrate layer. Then, the top surface of the reflective layer 120a is coated with the three-dimensional layer 120c. When using metallic ink to form the reflective layer 120a, it is possible to form the reflective layer 120a directly on the top surface of the substrate layer 110.

In addition, as shown in FIG. 2b, the reflective layer 120a may be patterned with a metal thin film or metal powder. The metal thin film and metal powder is provided as a thin film of a material, such as metal, reflected by light or as powder, and thus is used to form a desired pattern on the substrate layer 110. Then, the top surface of the reflective layer 120a is coated with the three-dimensional layer 120c. When forming the reflective layer 120a with a metal thin film or metal powder, a reflector fixing layer 120d is formed between the reflective layer 120a and the top surface of the substrate layer 110. In other words, the reflector fixing layer 120d is formed first at the site where the reflective layer 120a is to be formed, and then the reflective layer 120a is provided on the top of the reflector fixing layer 120d. In this manner, it is possible to form the reflective layer 120a on the top surface of the substrate layer 110.

Particularly, the reflective layer 120a may include a metal-based material, such as a metal thin film, metal powder or metallic ink, but any materials may be used as long as they have luminant properties. For example, it is possible to use dust generated after the workmanship of jewels, such as diamond, sapphire, ruby, etc., or glass. The three-dimensional layer 120c is provided on the top of the reflective layer 120a regardless of the particular type of the material, such as a metal thin film, metal powder or metallic ink, forming the reflective layer 120a. In other words, the thickness of the three-dimensional layer 120c allows the pattern printed on the reflective layer 120a to be finished as a three-dimensional ornament. In this manner, the three-dimensional layer 120c mirrors the shape of the reflective layer 120a, and thus allows the reflective layer 120a to be designed according to a desired shape of the three-dimensional ornamental portion 120. Therefore, it is possible to form the three-dimensional ornamental portions 120 having various designs with ease. In order to form the three-dimensional layer 120c, epoxy resins, silicone resins, acrylic resins, urethane resins, epoxy-silicone resin blends or acrylic-urethane resin blends may be used. Since the material used to form the three-dimensional layer 120c has low adhesion to the reflective layer 120a, the reflective layer 120a and the three-dimensional layer 120c are separated from each other with ease even under weak scratch. To solve this, the coating layer 120b is provided between the reflective layer 120a and the three-dimensional layer 120c, so that the three-dimensional layer 120c may be fixed stably on the top surface of the reflective layer 120a. Both the coating layer 120b and the three-dimensional layer 120c are formed of light transmittable transparent materials. Thus, when light is transferred to the reflective layer 120a, the reflective layer 120a realizes luminance. The three-dimensional layer 120c allows light to reach the reflective layer 120a and may include a dye or glitter to control the color and reflectance of the light reflected by the reflective layer 120a.

The three-dimensional layer 120c may be formed by any molding method, as long as the method enables molding of convex shapes. According to an embodiment, the three-dimensional layer 120c may be formed via a silk screen printing process so that the three-dimensional layer 120c has convex curvatures like water droplet shapes. The silk screen printing process may be used to form the three-dimensional layer 120c at the site where a luminant three-dimensional ornament, such as a jewel, is to be formed.

In other words, since the three-dimensional layer 120c may be applied only to the site provided with the coating layer 120b, it is possible to change the position of the three-dimensional layer according to the position of the coating layer 120b. For example, when only the site having the reflective layer 120a is provided with the coating layer 120b, the three-dimensional layer 120c is applied only to the top of the coating layer 120b. In addition, when the coating layer 120b is formed over the whole surface of the substrate layer 110 and the site to be realized with a three-dimensional ornament is limited to a predetermined portion of the substrate layer 110, the three-dimensional layer 120c is formed via a silk screen printing process to realize the thickness and pattern of the three-dimensional layer 120c according to the pattern of the reflective layer 120a. In other words, to realize the same effect as a three-dimensional ornament, epoxy resin is applied to a predetermined site many times repeatedly via a silk screen printing process, thereby forming a three-dimensional layer 120c. When providing the three-dimensional layer 120c with a convex curvature like the shape of a water droplet in the above-described manner, the three-dimensional layer 120c, through which light is transmitted, functions to collect the light like a convex lens. As a result, a greater amount of light is collected at the luminant material provided in the reflective layer 120a, thereby providing improved luminant property of the reflective layer 120a. In addition to this, the reflective layer 120a has an enlarged spectrum of design patterns, so that the three-dimensional ornamental portion 120 may have improved appearance. Particularly, the coating layer 120b applied to the reflective layer 120a may include at least one selected from UV resins, urethane resins, acrylic resins, cellulose resins, polyester resins, vinyl resins, polyamide resins, epoxy resins, alkyd resins and latex-casein.

In addition, the contact angle 8 of the three-dimensional layer 120c having a convex curvature like a water droplet means the angle formed between the tangent line at the bottom of the three-dimensional layer 120c that is in contact with the coating layer 120b and the bottom surface of the three-dimensional layer 120c, and is measured at the inner side of the three-dimensional layer 120c. Particularly, the three-dimensional layer 120c may have a contact angle θ of 20° to 70°. When the contact angle 8 of the three-dimensional layer 120c is larger than 70°, the top surface of the three-dimensional layer 120c may have an excessively convex curvature, thereby limiting the light collection site to a local portion. When the contact angle θ of the three-dimensional layer 120c is less than 20°, the top surface of the three-dimensional layer 120c is too flat to provide sufficient light collection, and thus it is not possible to improve the luminant property of the reflective layer 120a. Therefore, the three-dimensional layer 120c may have a contact angle θ of 20° to 70°.

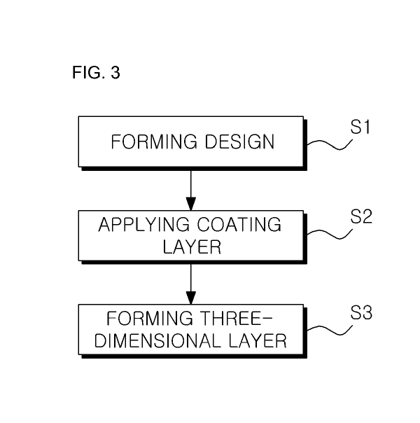

FIG. 3 is a flow chart illustrating the method for manufacturing a bling nail sticker according to an embodiment.

The method for manufacturing a bling nail sticker disclosed herein includes:

forming a pattern including the shape of a reflective layer 120a on the top of a substrate layer according to a target design pattern (S₁);

applying a coating layer 120b to a site where a three-dimensional ornamental portion is to be formed (S₂); and

forming a three-dimensional layer 120c at the coating layer-applied site where a three-dimensional ornamental is to be formed (S₃).

In the operation (S₁) of forming a design, the target design of a bling nail sticker is printed. The design includes not only the design corresponding to the shape of the three-dimensional ornamental portion 120 but also the design corresponding to the planar shape. In other words, in addition to forming the pattern with a light reflective material like the reflective layer 120a, the design pattern non-reflective to light is also printed. After the operation (S₁) of forming a design, an operation (S₂) of applying a coating layer 120b on the top of the substrate layer 110 is carried out. In the operation (S₂) of applying a coating layer, the coating layer may be applied only to the site where the three-dimensional ornamental portion 120 is to be formed, or to the whole surface of the substrate layer 110. After the completion of the application of the coating layer, an operation (S₃) of forming a three-dimensional layer 120c is carried out. In the operation (S₃), the three-dimensional layer 120c is coated at the site where the reflective layer 120a is formed. In this manner, it is possible to manufacture the bling nail sticker disclosed herein.

As can be seen from the foregoing, the bling nail sticker disclosed herein has a three-dimensional layer having a convex curvature on the top of a reflective layer, so that a three-dimensional ornamental portion may be positioned at a predetermined site in the same manner as attaching a jewel to the site. In addition, since the three-dimensional ornamental portion is provided by using a printing process, it is possible to control the size and position of the three-dimensional ornamental portion with ease, resulting in a decrease in time and improvement in cost-efficiency during the manufacture. Therefore, it is possible to provide a bling nail sticker at low cost. Further, even when non-skilled persons intend to improve the appearance of their nails, they may select a desired design with ease and apply the same to their nails more conveniently.

While the present invention has been described with respect to the specific embodiments, it will be apparent to those skilled in the art that various changes and modifications may be made without departing from the spirit and scope of the invention as defined in the following claims.

1.-12. (canceled)

13. A method for manufacturing a bling nail sticker, comprising:
forming a pattern including a reflective layer on only a part of the top of a substrate layer according to a target design pattern;
applying a transparent coating layer to the reflective layer; and
forming, via a silk screen printing process, a substantially transparent three-dimensional layer on the transparent coating layer, such that the substantially transparent three-dimensional layer covers the reflective layer and the reflective layer is visible through the three-dimensional layer;
wherein the silk screen printing process forms the substantially transparent three-dimensional layer as a plurality of sequentially-formed sub-layers.

14. The method according to claim 13, wherein the transparent coating layer is applied to the whole surface of the substrate layer.

15. The method according to claim 13, further comprising adhering the substrate layer to a release sheet.

16. The method according to claim 13, wherein the substrate layer is substantially planar during the silk screen printing process.

17. The method according to claim 13, wherein forming the reflective layer on only a part of the top of the substrate layer further comprises forming a reflector fixing layer between the reflective layer and the substrate layer.

18. The method according to claim 13, wherein forming the substantially transparent three-dimensional layer further comprises combining at least one of a dye and glitter with a transparent material of the substantially transparent three-dimensional layer.

19. The method according to claim 13, wherein the pattern including the reflective layer is formed with metallic ink.

20. The method according to claim 13, wherein the pattern including the reflective layer is formed with at least one of a metal thin film and metal powder.

21. The method according to claim 13, wherein the substrate layer is obtained by using at least one selected from polyethylene terephthalate (PET), oriented polypropylene (OPP), polypropylene (PP), polystyrene (PS), polyethylene (PE), polyvinyl chloride (PVC), polyvinylidene chloride (PVDC), ethylene vinyl acetate (EVA), polyurethane (PU) and paper sheets.

22. The method according to claim 13, wherein the coating layer comprises at least one selected from UV resins, urethane resins, acrylic resins, cellulose resins, polyester resins, vinyl resins, polyamide resins, epoxy resins, alkyd resins and latex-casein.

23. The method according to claim 13, wherein the three-dimensional layer comprises any one selected from epoxy resins, silicone resins, epoxy-silicone resin blends, acrylic resins, urethane resins, and acrylic-urethane resin blends.

24. The method according to claim 13, wherein the three-dimensional layer has a convex curvature so that light is collected at the reflective layer.

25. The method according to claim 24, wherein the three-dimensional layer has a contact angle of 20° to 70°.

26. A method for manufacturing a bling nail sticker, comprising:
forming a pattern including a reflective layer on only a part of the top of a substrate layer according to a target design pattern;
applying a transparent coating layer to the reflective layer; and
forming a substantially transparent three-dimensional layer on the transparent coating layer, such that the substantially transparent three-dimensional layer covers the reflective layer and the reflective layer is visible through the three-dimensional layer.
